(19) United States
(12) Patent Application Publication
(10) Pub. No.: US 2014/0075279 A1
(43) Pub. Date: Mar. 13, 2014

(54) Data-Value Centered Programming

(71) Applicant: Samir Issa, Riyadh (SA)

(72) Inventor: Samir Issa, Riyadh (SA)

(21) Appl. No.: 13/613,233

(22) Filed: Sep. 13, 2012

(51) Int. Cl. G06F 17/30; G06F 17/24

(52) U.S. Cl. CPC G06F 17/30289; G06F 17/243
USPC 715/221; 707/803

(57) ABSTRACT

The current invention is a system, method and program product that defines a platform composed of two basic software modules that capture, store, and retrieve data in any business domain regardless of the nature of the business itself or its transactional rules. The platform achieves its objective by concentrating on data values themselves and their own meta data rather than on any other information—such as business rules—that is related to these data values. The first module is a Template Manager that creates data item group templates and their component data items and the second module is a Template Manager Client.

### CROSS-REFERENCES TO RELATED APPLICATIONS (IF ANY)

None

### STATEMENT AS TO RIGHTS TO INVENTIONS MADE UNDER FEDERALLY-SPONSORED RESEARCH AND DEVELOPMENT (IF ANY)

None

### BACKGROUND OF INVENTION

1. Field of the Invention

The present invention is a platform composed of two basic software modules that capture, store, and retrieve data in any business domain regardless of the nature of the business itself or its transactional rules.

2. Background

In all business domains and transactions, the capture of data is done through electronic forms that customarily store data in tables. Usually the tables are designed either according to the process steps—procedural programming—or by mapping business transactions to software objects—object oriented programming—. In both cases, the resultant forms and tables are multiple creating visual sensory overload for the forms, and programming sophistication for the tables.

There is still room for improvement in the art.

### SUMMARY OF THE INVENTION

The current invention is a system, method and program product that defines a platform composed of two basic software modules that capture, store, and retrieve data in any business domain regardless of the nature of the business itself or its transactional rules. The platform achieves its objective by concentrating on data values themselves and their own metadata rather than on any other information—such as business rules—that is related to these data values.

The first module is a Template Manager that creates data item group templates and their component data items. It is used to permit power-users of a particular business domain to identify domain-specific data items, to group those data items in sets and store the sets as templates, and to define the relations between the sets/templates.

The second module i.e. Template Manager Client that permits the end user 10 to do the following: allowing on-demand retrieval of already created and stored templates, displaying a set of data items in the context of a data item group either as a form, or as an action/transaction, having data items that are displayed only as empty text boxes and their labels (names), permitting the user to input the ‘value’ attribute value, and modify it using available tools, performing basic business rule processing of the entered value using the hidden attributes of the data item, and storing the entered values in the data base once the user decides to save the form.

### BRIEF DESCRIPTION OF THE DRAWINGS

Without restricting the full scope of this invention, the preferred form of this invention is illustrated in the following drawings:

FIG. 1 is a diagram of the elements and the assembly of a Mobject Template;

FIG. 2 is a diagram of a ready Mobject Template with Filled Metadata stored in a Template Pool;

FIG. 3 is a diagram of End-user adds runtime meta data to Mobject elements;

FIG. 4 is a diagram of a template updated with runtime data that is shown to the End Users as a form;

FIG. 5 shows where a User enters ‘Value’ in an empty value field;

FIG. 6A displays that User Entered Values are saved in production database with template and dynamic and static metadata;

FIG. 6B displays User Entered Values being saved in production database with dynamic metadata only; and

FIG. 7 is a block diagram showing a basic arrangement of a computer system that can run the current invention.

### BRIEF DESCRIPTION OF THE PREFERRED EMBODIMENTS

There are a number of significant design features and improvements incorporated within the invention.

In the current art, in all business domains and transactions, the capture of data is done through electronic forms that customarily store data in electronic store in tables. Usually the tables are designed either according to the process steps—procedural programming—or by mapping business transactions to software objects—object oriented programming—. Many times in these cases, the resultant forms and tables are multiple thus creating visual sensory overload for the forms, and programming sophistication for the tables.

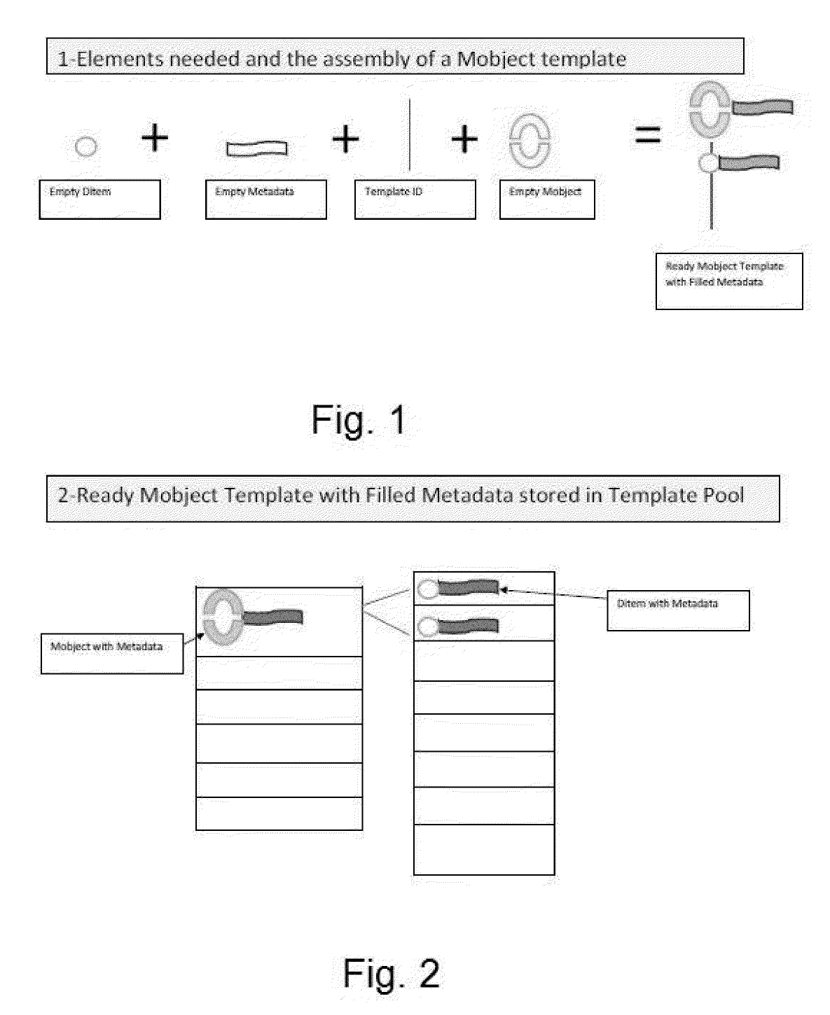

As shown in FIGS. 1 through 6B, the current invention is a system 1, method and program that define a platform composed of two basic software modules that capture, store, and retrieve data in any business domain regardless of the nature of the business itself or its transactional rules. With this platform design, data entered by the end user 10 is stored in the production database in three tables only; this is done regardless of the business nature, domain rules, or complexity.

The storage and databases for the system may be implemented by a single data base structure stored in an electronic readable form at an appropriate site, or by a distributed data base structure that is distributed across an intra or an Internet network as shown in FIG. 7.

This is a concept design of a process that simplifies user interface presentation and data storage in software applications.

The concept defines a platform composed of two basic software modules that capture, store, and retrieve data in any business domain regardless of the nature of the business itself or its transactional rules. The platform achieves its objective by concentrating on data values themselves and their own metadata rather than on any other information—such as business rules—that is related to these data values.

The first module is a Template Manager that creates data item group templates and their component data items. It is used to permit power-users of a particular business domain to identify domain-specific data items, to group those data items in sets and store the sets as templates, and to define the relations between the sets/templates.

It is natural therefore, that the first module comes in versions differing according to the nature of domain i.e. it is domain specific, e.g. the Template Manager for a hospital is different from that of a car factory. It is conceivable that in any business domain, a finite number of data items will be needed albeit that this number could be increased, if needed, by the power-user of the particular enterprise who feels that such an increment is required to meet the special business rules and needs of the enterprise.

Definition of data items starts by defining domain/enterprise work groups that use the same forms to transact with other groups. Each group defines the forms and transactions/actions that it needs to use when transacting. Each form or transaction/action is considered a data item grouper, the process of defining data items occurs then within the definition of a data item group itself.

When a power user defines a domain specific data item, he will be requested to attach to it a set of attributes that will be used later to apply domain business rules and user interface formatting. The data item holds a unique data item code that renders duplication of a data item impossible, this is done by deriving the code from the data item name and testing any new data item for any potential duplication prior to adding it in the template database.

A data item has three sets of attributes:

The first set includes the name of the data item, its unique code in the system, and other attributes defining formatting and business rules, this first set is filled by the power user when they are creating the template.

The second set of data item attributes is filled by the software system when the data item is consumed by the end user 10.

The third set of data item attributes include the special ‘value’ attribute of the data item specifically edited by the end user 10, and some other attributes that could modify it.

The second module i.e., which is the Template Manager Client, permits the end user 10 to do the following:

1—On-demand retrieve already created and stored templates.

2—Display a set of data items in the context of a data item group either as a form, or as an action/transaction. Data items are displayed only as empty text boxes and their labels (names).

3—Permits the end user 10 to input the ‘value’ attribute value, and modify it using available tools.

4—Perform basic business rule processing of the entered value using the hidden attributes of the data item.

5—Store the entered values in the data base once the user decides to save the form.

The first table stores the data item attributes that have been modified in runtime by the user and the system, and the attributes that are needed to filter retrieval and editing. This means that data item attributes already stored in the data item template, and are neither modified in runtime or required for retrieval and editing, are not stored because they are readily available from the template database store using the unique data item code. The second table stores the runtime modified information pertaining to the data item groups, and the set of group attributes.

The third table stores the relations between the data items groups.

The reduction of production database tables to three generic tables only, regardless of the business nature and complexity, simplifies to a great extent coding for applications that will consume the data later whether consumption is for retrieval/editing purposes, or for further online analytical and processing purposes. From database point of view the performance of On Line Analytical Processing, data retrieval, data editing improves with the reduction of number of tables in the database.

The design empowers enterprises and businesses to define their own sets of data items and of templates, and to define the relations between the templates as well, this means that the streamlining of the business processes itself could be defined in this way permitting the enterprise of building protocols and pathways of their business processes.

The definition of the template serves ultimately to structure business delivery and application of rules in a way that renders performance of individual members reflective of the templates design rather than their own personal adherence to defined business rules. e.g. in a hospital environment defining templates for dealing with patients in special situations will reduce chances of human error and avoids exposure to litigation.

Enterprises and their information application developer are the potential users of the process. The platform will be provided as two generic software modules. Software application developer, depending on the enterprise requirements, will be able to modify the code of the generic modules. When the platform is functional on an enterprise network, it will serve to generate a data store that will function as a data repository composed of all the data item values, and data item groups and relations. The data in this repository could be consumed later in custom-made applications in the enterprise for any particular purpose e.g. An accounting application of an enterprise can consume production stored data items to perform particular accounting transactions necessary for the enterprise. This particular accounting application will be therefore a client of the platform and will be built in order to consume its data.

The design controls data flow and registers all data values generated during business transactions in a certain business domain.
Examples of business domains:
   Health Care Provision
   Health Care Insurance
   Educational Institutions

Differently from current concepts, practices, and applications, this design abstracts the data, processes it, and persist it using three primary objects regardless of the nature and complexity of the business domain and the transactions themselves.

The three objects are: a master object herein called Mobject, a second object herein called Ditem which holds one value attribute of the master object along with the metadata that harbors all of the quantitative, qualitative, and display information of the value attached to this particular value, and a third object herein called MobjectGroup that defines sets of the master object

The software platform permits business domain advanced users to pre-define templates for web forms.

The defined templates hold attributes that vary according to business domain and define the business rules that control values.

When the end user 10 recalls the templates, they get displayed as forms with empty field values.

When the end user fills in the values, the data is processed to ensure conformity to business rules as per the related Ditem attributes fields.

Upon successful validation, the data is persisted in a data store that represents the three primary objects and their internal relations.

This design empowers business advanced users, i.e. domain experts, with the ability to define business objects as Mobjects described fully by items, and business operations as MobjectGroups and to store all as templates. This grants the business a great flexibility in defining and changing business protocols, and policies and procedures in response to changing needs and business rules.

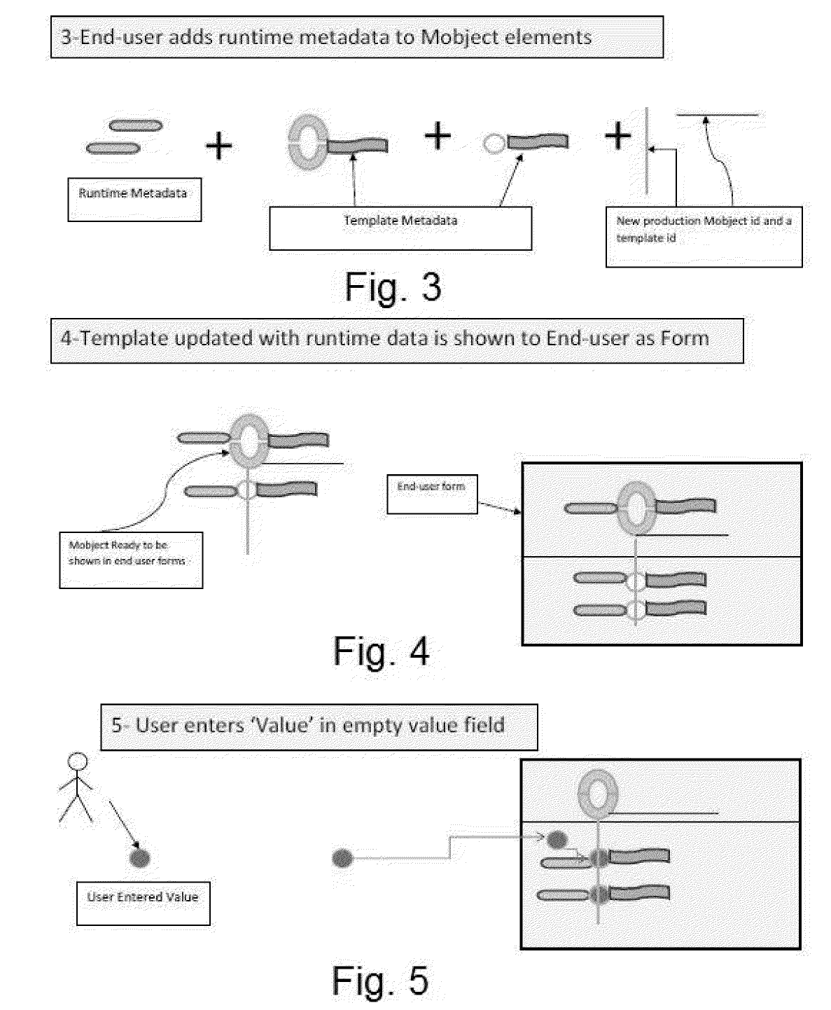

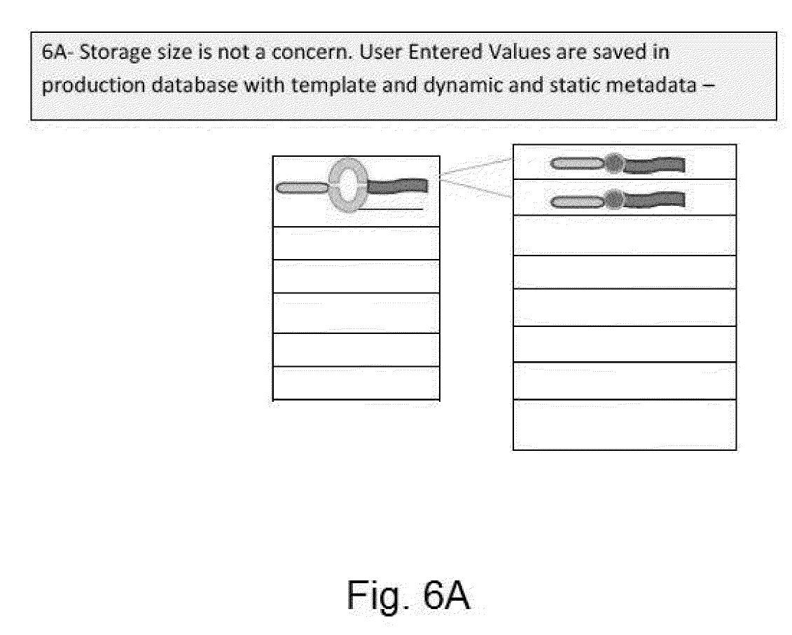

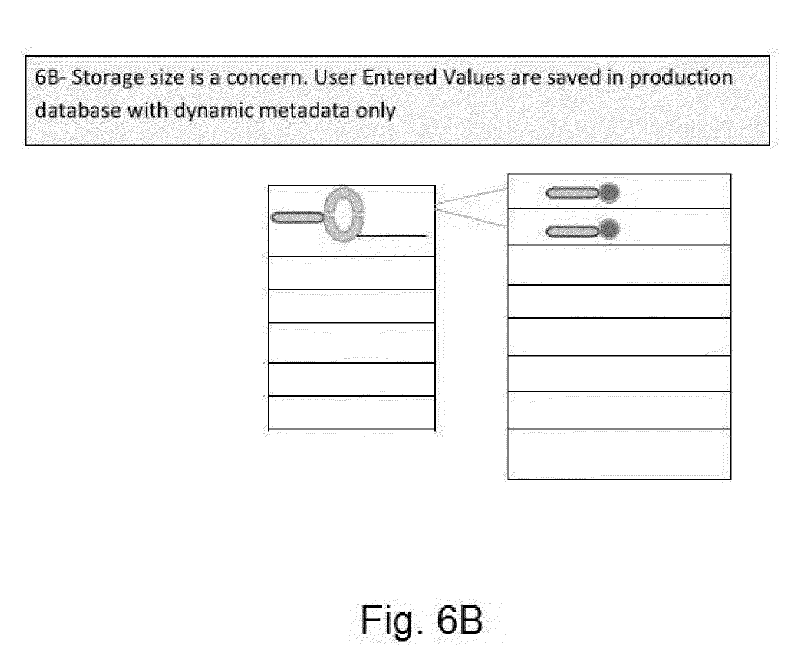

FIG. 1 shows a ready mobject template with filled metadata being formed from an empty ditem, an empty metadata, a template ID and an empty Mobject. FIG. 2 shows a ready mobject template with Filled Metadata stored in a Template Pool. FIG. 3 shows End-user adds runtime meta data to being added to Mobject elements. FIG. 4 shows a template being updated with runtime data that is shown to the End Users 10 as a form 20. FIG. 5 shows where a User 10 enters a ‘Value’ in an empty value field. FIG. 6A shows that in the current invention when storage size is not a concern the end user 10 enters values that are saved in production database with temple and dynamic and static metadata while, as shown in FIG. 6B if storage space is a concern then it is saved in production database with dynamic metadata only.

The system 1 is set to run a on a computing device 11. A computing device on which the present invention can run would be comprised of a CPU, Hard Disk Drive, Keyboard, Monitor, CPU Main Memory and a portion of main memory where the system resides and executes. A printer can also be included. Any general purpose computer with an appropriate amount of storage space is suitable for this purpose. Computer Devices like this are well known in the art and are not pertinent to the invention. The system can also be written in a number of different languages and run on a number of different operating systems and platforms. The system is network based and works on an Internet, Intranet and/or Wireless network basis as well as a stand alone system.

As shown in FIG. 7, the users 10 would access the system 1 through a network 100 or Internet 500. The system's software would reside in the system's memory 310. There are a number of different components of the system 1, these are described below.

The system 1 uses a memory means such as a standard hard drive or any other standard data storage device to store the data.

Advantages

The fact that data is stored and managed by three objects only has the following advantages: its facilitates enormously the implementation of business rules; it allows for the sharing of data, it allows that retrieving and sorting of stored data through specifically built software modules; it allows online analysis and processing of business data (OLAP) and it improves database performance

As to a further discussion of the manner of usage and operation of the present invention, the same should be apparent from the above description. Accordingly, no further discussion relating to the manner of usage and operation will be provided.

It should be appreciated that many other similar configurations are within the abilities of one skilled in the art and all of these configurations could be used with the method of the present invention. Furthermore, it should be recognized that the computer system and network disclosed herein can be programmed and configured by one skilled in the art in a variety of different manners to implement the method steps described further herein.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A method comprising the steps: a system running on a computer device having a plurality of software modules that capture, store, and retrieve data in any business domain where data entered by the end user is stored on electronic memory in the production database in a plurality of tables.

2. The method as defined in claim 1, wherein said first software module is a Template Manager that creates data item group templates and their component data items.

3. The method as defined in claim 2, where said second module is the Template Manager Client.

4. The method as defined in claim 2, where said Template Manager defines sets of data items groups starts by defining sets of work groups that use the same forms to transact with other groups.

5. The method as defined in claim 4, where said where said a set includes the name of the data item, its unique code in the system, and other attributes defining formatting and business rules,.

6. The method as defined in claim 4, where said where said set is data item attributes filled when the data item is created/edited by the power user.

7. The method as defined in claim 4, where said set includes special ‘value’ attribute of the data item specifically edited by the end user .

8. The method as defined in claim 2, where said Template Manager creates and groups data items as defined by work groups that use the same forms to transact with other groups, where each data item has three sets of attributes: first set includes the name of the data item, its unique code in the system, and other attributes generated by the software system itself, where second set is data item attributes filled when the data item is consumed by the power user, and where third set includes special ‘value’ attribute of the data item and other attributes that are specifically edited by the end user .

9. The method as defined in claim 2, where said where said Template Manager Client has on-demand capacity to retrieve already created and stored templates.

10. The method as defined in claim 9, where said where said Template Manager Client can display the set of data items in the context of a data item group either as a form, or as an action/transaction where data item are displayed only as empty text boxes representing the empty ‘Value’ attribute, and their labels derived from the data item name attribute.

11. The method as defined in claim 2, where said where said Template Manager Client permits the end user to input and modify the ‘value’ attribute value.

12. The method as defined in claim 2, where said where said Template Manager Client performs basic business rule processing of the entered value using the hidden attributes of the data item.

13. The method as defined in claim 2, where said where said Template Manager Client stores the entered values in the data base once the user decides to save the form.

14. The method as defined in claim 2, where user can define business objects and operations through the implementation of three objects described as: Mobjects described fully by other business objects called ‘Ditems’ where Ditems themselves are objects that hold a ‘Value’ attribute defined by a set of metadata that controls the business behavior and describes completely the value of the ‘Value’ attribute from a programming point of view. The third type of object is the MobjectGroup object that describes several types of relations between Mobjects. All the information generated through these processes is persisted in the production data repository in three tables.
